(19) United States
(12) Patent Application Publication
(10) Pub. No.: US 2017/0102712 A1
(43) Pub. Date: Apr. 13, 2017

(54) TRACTOR REMOTE CONTROL

(71) Applicant: CENTRAL MACHINERY SERVICES PTY LTD, Delacombe (AU)

(72) Inventor: Joshua Paul Nijam, Invermay (AU)

(21) Appl. No.: 15/290,862

(22) Filed: Oct. 11, 2016

(30) Foreign Application Priority Data
Oct. 12, 2015 (AU) 2015904140

(51) Int. Cl. G05D 1/02; A01B 76/00

(52) U.S. Cl. CPC G05D 1/0276; A01B 76/00; G05D 2201/0201

(57) ABSTRACT

Described embodiments relate to a receiver device for controlling agricultural machinery. The receiver device comprises a receiver module for communicating with an external device; throttle control circuitry in communication with the receiver module, configured to override a built-in throttle control mechanism of the machinery and allow for control of a throttle function of the machinery; ignition control circuitry in communication with the receiver module, configured to override a built-in ignition control mechanism of the machinery and allow for control of an ignition function of the machinery; and auxiliary apparatus control circuitry in communication with the receiver module, configured to override a built-in auxiliary apparatus control mechanism of the machinery and allow for control of an auxiliary apparatus function of the machinery. The device may control at least one of the throttle, ignition and auxiliary apparatus functions in response to control signals received at the receiver module from the external device.

### CROSS REFERENCE TO RELATED APPLICATION(S)

The present application claims priority to Australian Patent Application No. 2015904140, entitled, “TRACTOR REMOTE CONTROL,” filed Oct. 12, 2015, naming Joshua Paul Nijam as inventor, the disclosure of which is hereby incorporated by reference in its entirety.

### TECHNICAL FIELD

Described embodiments generally relate to methods and systems for the control of machinery functions. Embodiments also relate to methods of installing such systems.

### BACKGROUND

Many vehicles, such as tractors, have auxiliary machinery elements that are controlled from the driver's seat of the vehicle. For example, many tractors have a power take-off (PTO) shaft, which may be used to run a grain delivery auger, for example. The PTO must be turned on and off from the driver's seat within the cabin of the tractor, and the power to the PTO must be controlled from within the cabin, as well. However, in order to control and supervise the machinery adequately, someone is required to be outside the cabin watching the machinery when it is in operation.

Often, in a farm setting, operation of such machinery requires two people—one to sit inside the cabin of the vehicle, and one to supervise from outside. In some instances, one person may be able to control and supervise the work, but this would require them to get in and out of the vehicle continually while operating the machinery. This is tiresome and can be difficult to achieve for farmers who may be elderly, or have a disability.

It is desired to address or ameliorate one or more shortcomings or disadvantages associated with prior systems and methods relating to the control of machinery functions.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

Some embodiments relate to a receiver device for controlling agricultural machinery, comprising: a receiver module for communicating with an external device; throttle control circuitry in communication with the receiver module, configured to override a built-in throttle control mechanism of the machinery and allow for control of a throttle function of the machinery; ignition control circuitry in communication with the receiver module, configured to override a built-in ignition control mechanism of the machinery and allow for control of an ignition function of the machinery; and auxiliary apparatus control circuitry in communication with the receiver module, configured to override a built-in auxiliary apparatus control mechanism of the machinery and allow for control of an auxiliary apparatus function of the machinery; wherein the device is configured to control at least one of the throttle function, the ignition function and the auxiliary apparatus function in response to control signals received at the receiver module from the external device.

The ignition control circuitry may be configured to allow at least one ignition safety feature of the machinery to continue to operate when the built-in ignition control mechanism of the machinery is overridden.

The receiver may be configured to be removably installable in the machinery.

The receiver may be configured to be plugged into a wiring harness of the machinery.

The receiver may be configured to be able to control at least two pieces of machinery, the at least two pieces of machinery having different idle and high idle voltages from each other.

The receiver may comprise a plug having at least two sections, each section of the plug being adapted to be used with a piece of machinery having a particular idle and high idle voltage.

Some embodiments relate to a kit for retrofitting to agricultural machinery comprising: the receiver device according to some embodiments described above; a transmitter device comprising: a transmitter module for communicating with the receiver module of the receiver device; throttle control circuitry configured to receive input from a user and to communicate with the transmitter module based on the input; ignition control circuitry configured to receive input from a user and to communicate with the transmitter module based on the input; and auxiliary apparatus control circuitry configured to receive input from a user and to communicate with the transmitter module based on the input.

The may further comprise a wiring harness configured to be installed in the machinery, the receiver being configured to plug into the wiring harness.

### BRIEF DESCRIPTION OF THE DRAWINGS

Embodiments are described in further detail below, by way of example and with reference to the accompanying drawings, in which:

FIG. 1 shows an example system for the remote control of machinery functions according to some embodiments;

FIG. 2 shows a receiver from the system of FIG. 1;

FIG. 3 shows a transmitter from the system of FIG. 1;

FIG. 4 shows a circuit diagram of the receiver of FIG. 2:

FIG. 5 shows a circuit diagram of the transmitter of FIG. 3;

FIG. 6 shows a circuit diagram of wiring between components of the tractor and receiver of FIG. 1;

FIG. 7 shows an alternative embodiment of the receiver of FIG. 1;

FIG. 8 shows an alternative embodiment of the circuit diagram of the receiver of FIG. 2; and

FIG. 9 shows an alternative embodiment of the circuit diagram of the transmitter of FIG. 3.

### DETAILED DESCRIPTION OF EMBODIMENTS

Described embodiments generally relate to methods and systems for the control of machinery functions. Embodiments also relate to methods of installing such systems.

Some embodiments relate to controlling the functions of agricultural or industrial machinery and equipment, such as tractors, trucks, excavators, harvesters, planters, diggers, bulldozers, loaders, backhoes, forklifts, pumps, stationary engines, engines and cranes. Some embodiments relate to remotely controlling the functions of this machinery.

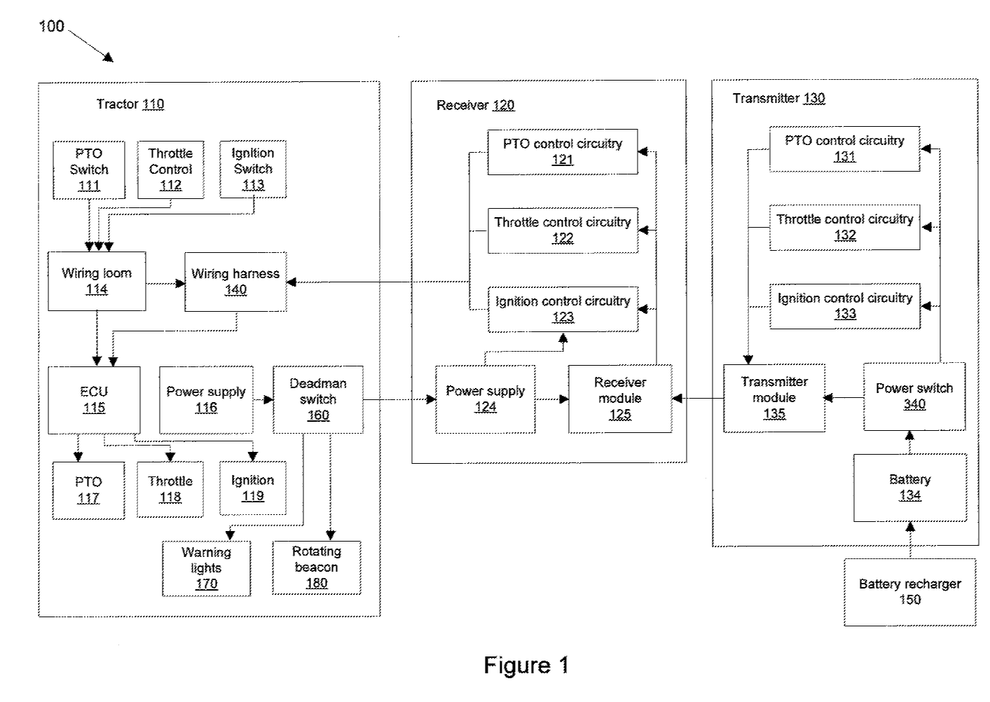

FIG. 1 shows an example system 100 for controlling the functions of a tractor 110. In some embodiments, tractor 110 may be a John Deere 6140R tractor, or a similar tractor, for example. In some embodiments, tractor 110 may be another kind of agricultural or industrial machinery, such as an excavator, harvester, planter, digger, bulldozer, loader, backhoe, forklift, pump, stationary engine, engine or crane. Tractor 110 has a number of controllable parts, which may include an auxiliary apparatus such as power take-off (PTO) 117, throttle 118 and ignition 119. These parts may be controllable by PTO switch 111, throttle control 112 and ignition switch 113, respectively. In some embodiments, PTO switch 111 may be a push-button switch, a rotatable switch, or another type of electro-mechanical switch. Throttle control 118 may be a lever or dial in some embodiments. Ignition switch 113 may be a push button switch, or a rotatable switch requiring the insertion of a key to be operated. In some embodiments, tractor 110 may have other auxiliary apparatus, such as hydraulic levers and a three-point linkage, which may be able to he controlled by system 100.

Tractor 110 has a wiring loom 114 connecting the PTO switch 111, throttle control 112 and ignition switch 113 to an electronic control unit (ECU) 115, which controls PTO 117, throttle 118 and ignition 119. Wiring loom 114 may comprise a number of cables, providing wired communication between the electrical components of tractor 110. In the normal operation of tractor 110, manipulating PTO switch 111 will cause the PTO 117 to turn on and off. Manipulating throttle control 112 will alter the amount of power being supplied to throttle 118. Manipulating ignition switch 113 will control ignition 119, to cause tractor 110 to start and stop the tractor engine. Tractor 110 may have a power supply 116 which may include a battery and an engine in some embodiments, and power supply 116 may power the operations of PTO 117, throttle 118 and ignition 119.

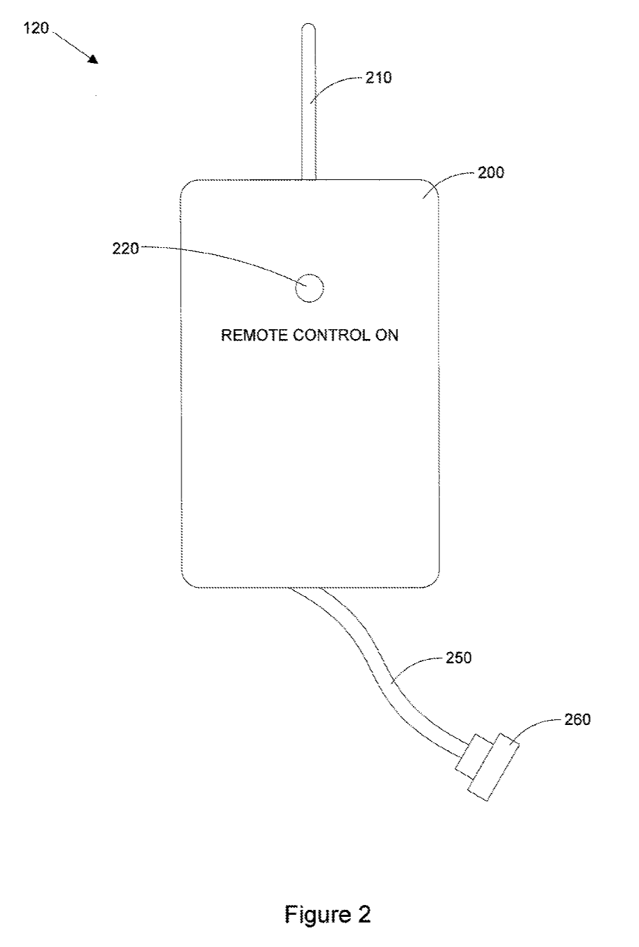

According to some embodiments, tractor 110 may include a wiring harness 140 which may, in some embodiments, be installed as a retrofit to tractor 110. Wiring harness 140 may be installed between wiring loom 114 and ECU 115. Wiring harness 140 may be hard-wired into wiring loom 114. Tractor 110 may be in communication with a receiver 120 through wiring harness 140. Wiring harness 140 may comprise a socket (not shown), into which a plug 260 (see FIG. 2) of receiver 120 may be able to connect, in order to allow wired communication between tractor 110 and receiver 120. The socket and plug may comprise waterproof connectors in some embodiments. In some embodiments, a dummy plug (not shown) may be configured to plug into the socket of wiring harness 140 when plug 260 is not plugged in. In some embodiments, receiver 120 may be able to be plugged into any tractor 110 that has been installed with a wiring harness 140 as described.

Receiver 120 includes a power supply 124, which may be connected to and derive power from power supply 116 of tractor 110. Power supply 124 may be connected to power supply 116 through a dead-man switch 160. In this embodiment, when dead-man switch 160 is closed, receiver 120 is powered by tractor 110. Opening dead-man switch 160 prevents power from being supplied to receiver 120. Power supply 124 supplies power to components of receiver 120, which may include PTO control circuitry 121, throttle control circuitry 122 and ignition control circuitry 123. Dead-man switch 160 may further allow power to be supplied to warning lights 170 and rotating beacon 180, as a safety mechanism to indicate that tractor 110 is being remotely controlled. Other visual and audible indicators, instead of or as well as warning lights 170 and rotating beacon 180, may also be used to indicate that tractor 110 is being remotely controlled.

As well as dead-man switch 160, some embodiments may include a shut-off timer (not shown) to allow tractor 110 to be shut-off after a predetermined time period has elapsed. This may be particularly useful for when tractor 110 is being used to run pumps for irrigation purposes, for example.

Receiver 120 further includes a receiver module 125, which may be a two or four channel wireless receiver module in some embodiments. In some other embodiments, receiver module 125 may be a one, three, five, six, seven, eight, nine, or ten channel receiver. In some embodiments, receiver module 125 may have more than ten channels. For example, receiver module 125 may be an MTC-4DAO-433.920 or an MTC-2AO-433.920 by Embedded Communication Systems Ltd (ECS). In some embodiments, receiver module 125 may comprise more than one wireless receiver.

Receiver module 125 is configured to send signals to PTO control circuitry 121, throttle control circuitry 122 and ignition control circuitry 123 in some embodiments, PTO control circuitry 121, throttle control circuitry 122 and ignition control circuitry 123 send signals through cable 250 (see FIG. 2) to wiring harness 140 of tractor 110. The signals received by wiring harness 140 may be communicated to ECU 115 in order to control PTO 117, throttle 118 and ignition 119. Receiver module 125 is in communication with transmitter module 135 of transmitter 130. The communication may be wireless communication in some embodiments.

Transmitter 130 has PTO control circuitry 131, throttle control circuitry 132 and ignition control circuitry 133, each of which may be adapted to receive user input. PTO control circuitry 131, throttle control circuitry 132 and ignition control circuitry 133 may be configured to convert user input into electronic data signals. The electronic data signals may be communicated to transmitter module 135, which may be a two or four channel wireless transmitter module in some embodiments. In some other embodiments, transmitter module 135 may be a one, three, five, six, seven, eight, nine, or ten channel transmitter. In some embodiments, transmitter module 135 may have more than ten channels. For example, transmitter module 135 may be an MTC-4DAI-433.920P or an MTC-2DI-433.920P by Embedded Communication Systems Ltd (ECS). In some embodiments, transmitter module 135 may comprise more than one wireless transmitter.

Transmitter 130 further has a power supply such as battery 134, and a power switch 340. When power switch 340 is closed, battery 134 supplies power to components of transmitter 130, which may include PTO control circuitry 131, throttle control circuitry 132, ignition control circuitry 133 and transmitter module 135. Battery 134 may be a rechargeable battery, and may be configured to be connected to a battery charger 150. Battery charger 150 may be configured to be plugged into a mains power supply or a vehicle cigarette lighter in some embodiments.

FIG. 2 shows an example receiver 120. Receiver 120 has a housing 200 which may be of a size and shape that can be hand held. In some embodiments, housing 200 may be of a size that is too large to be hand held. Housing 200 contains the electronic components of receiver 120 including PTO control circuitry 121, throttle control circuitry 122 ignition control circuitry 123, and receiver module 125. Receiver module 125 may be in communication with an antenna 210, which may protrude from housing 200. Receiver 120 may have a remote control indicator 220 to indicate that receiver 120 is being supplied with power through dead-man switch 160 and is controlling tractor 110. When dead-man switch 160 is open, remote control indicator 220 may be turned off. Indicator 220 may be an LED in some embodiments.

When dead-man switch 160 is open, indicator 220 may be turned off. Receiver 120 may communicate with tractor 110 to cause tractor 110 to operate in a standard way, without allowing external control of the controllable elements of tractor 110. When switch 160 is closed, indicator 220 may be turned on. Receiver 120 may communicate with tractor 110 to cause tractor 110 to operate based on instructions received from transmitter 130, allowing external control of the controllable elements of tractor 110.

Receiver 120 has a cable 250 in communication with a plug 260. Cable 250 may communicate with electronic components of receiver 120 such as PTO control circuitry 121, throttle control circuitry 122, ignition control circuitry 123 and power supply 124. Plug 260 may be configured to plug into a socket (not shown) of wiring harness 140 of tractor 110. Plug 260 may have between 20 and 100 pins, and may be a 40 pin plug in some embodiments. In some other embodiments, plug 260 may have less than 20 or more than 100 pins. Cable 250 and plug 260 may allow data signals to be sent from PTO control circuitry 121, throttle control circuitry 122 and ignition control circuitry 123 through wiring harness 140 to ECU 115. Plug 260 may further allow power to be supplied from power supply 116 of tractor 110 to power supply 124 of receiver 120.

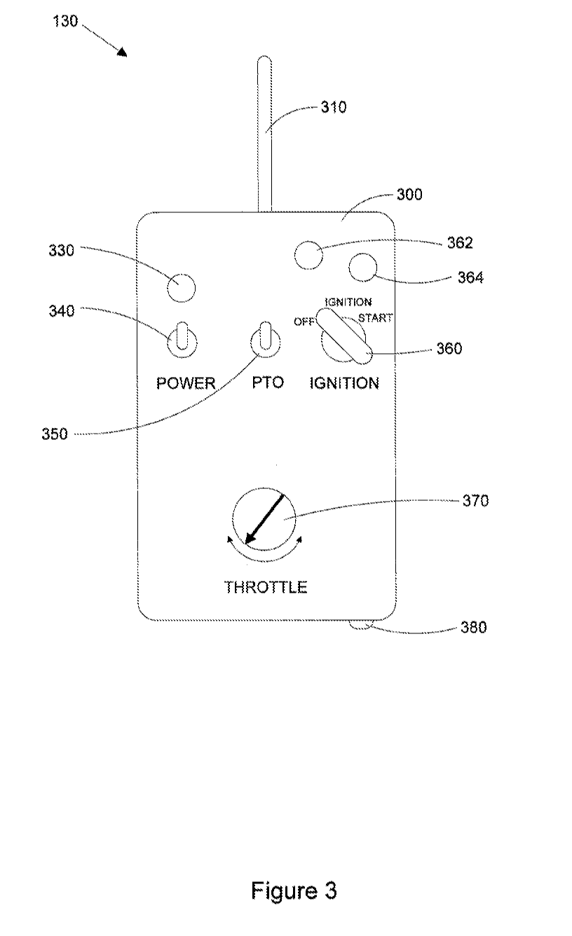

FIG. 3 shows an example transmitter 130. Transmitter 130 has a housing 300 which may be of a size and shape that can be hand held. Housing 300 contains the electronic components of transmitter 130 including PTO control circuitry 131, throttle control circuitry 132 ignition control circuitry 133, and transmitter module 135. Transmitter module 135 may be in communication with an antenna 310, which may protrude from housing 300. Transmitter 130 may have a power switch 340 and a power indicator 330. In some embodiments, power switch 340 may be a push-button switch, a rotatable switch, or other electro-mechanical switch, or another user interface component that allows a user to turn transmitter 130 on and off. Indicator 330 may be an LED or other visual, audible, or other indicator to indicate to a user whether transmitter 130 is on or off.

Transmitter 130 has PTO switch 350. PTO switch 350 may be in communication with PTO control circuitry 131, and may allow a user to remotely turn on and off PTO 117 of tractor 110. In some embodiments PTO switch 350 may be a push-button switch, rotatable switch or toggle switch, and in some embodiments may be a missile switch or other covered switch to prevent inadvertent toggling.

Transmitter 130 further has an ignition switch 360. In some embodiments, ignition switch 130 may be a push button switch, toggle switch, or a rotatable switch requiring the insertion of a key to be operated. Ignition switch 130 may allow a user to remotely start tractor 110 by allowing control of ignition 119. In some embodiments, ignition switch 130 may be a rotatable switch having multiple positions, such as “Off”, “Ignition” and “Start” positions. Transmitter 130 may have indicators to indicate to a user the position of ignition switch 130. For example, transmitter 130 may have an ignition indicator 362 and a start indicator 364. Indicators 362 may be LEDs in some embodiments, and may be of different colours. In some embodiments, indicators 362 and 364 may both be off when ignition switch 130 is in the “Off” position. If ignition switch 130 is turned to the “Ignition” position, ignition indicator 362 may turn on. If ignition switch 130 is switched to the “Start” position, start indicator 364 may turn on.

Transmitter 130 also has a throttle dial 370, which may be a lever or dial in some embodiments. Throttle dial 370 may allow a user to control throttle 118 of tractor 110.

In some embodiments, where tractor 110 may have other controllable parts, such as hydraulic levers and a three-point linkage, transmitter 130 may have further user-adjustable controls to allow a user to control each of the controllable functions.

Transmitter 130 has a power plug socket 380 to accept a battery recharger 150 to allow for battery 134 to be charged. Socket 380 may be a USB or mini-USB socket in some embodiments. In some embodiments, socket 380 may be a 12 V jack. Battery recharger 150 may be configured to plug into mains power in some embodiments. In some embodiments, battery recharger 150 may be configured to plug into a cigarette lighter of a vehicle such as tractor 110.

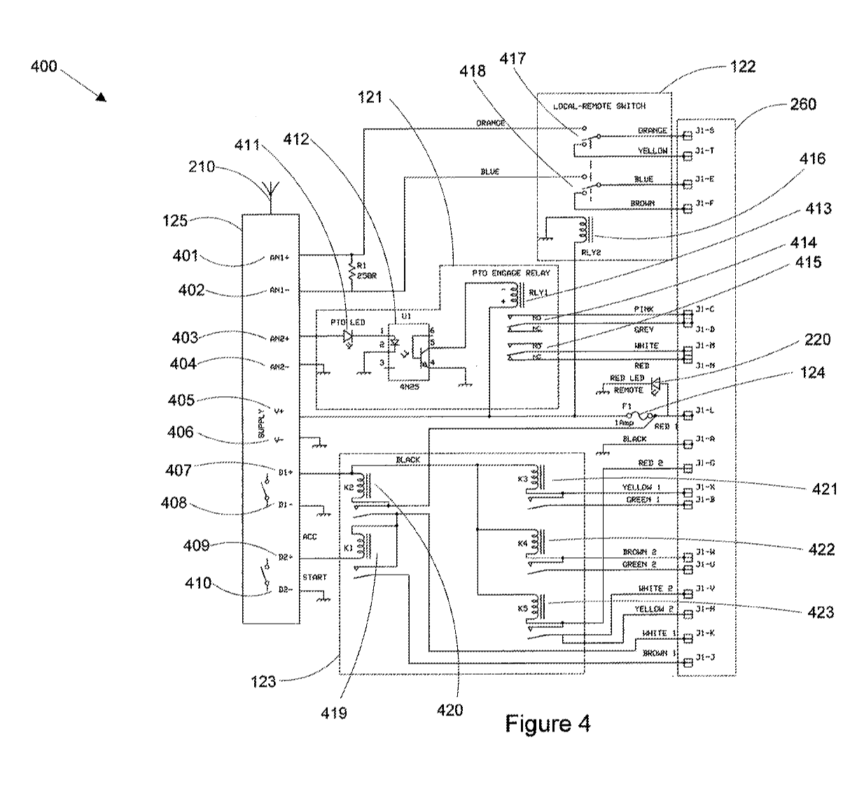

FIG. 4 shows a circuit diagram 400 of the electrical components of receiver 120. Receiver 120 includes receiver module 125, connected to antenna 210. Receiver module 125 receives data signals from antenna 210 and outputs data signals to PTO control circuitry 121, throttle control circuitry 122 and ignition control circuitry 123 through outputs 401 to 410. Outputs from PTO control circuitry 121, throttle control circuitry 122 and ignition control circuitry 123 are passed to plug 260 which connects to wiring harness 140, to enable control of tractor 110. In the illustrated embodiment, one receiver module 125 is shown, but in some embodiments a different number of receiver modules, such as two, three, four, five, or more, may be used.

Receiver 120 has a power supply 124 connected to plug 260 to receive power from power supply 116 of tractor 110. Receiver 120 also has power indicator 220 powered by power supply 124 when power supply 124 is receiving power from power supply 116. Power indicator 220 is a red LED in the illustrated embodiment, but may be a different coloured LED, or another type of visual, audible, or other indicator in some embodiments. Power supply 124 supplies power to positive supply channel 405 of receiver module 125. Negative supply channel 406, as well as negative output channels 404, 408 and 410 of receiver module 125 are connected to Earth. Power supply 124 powers relays 413, 416, 420, 421, 422 and 423 when power supply 124 receives power from power supply 116 through dead-man switch 160. Although power is supplied to these relays, no action will result due to the relays not being connected to Earth.

PTO control circuitry 121 may receive PTO control signals from AN2+ channel 403 of receiver module 125. PTO circuitry 121 may include PTO indicator 411, which may be an LED in some embodiments. PTO indicator 411 may be internal of the receiver housing 200 in some embodiments, and only visible when housing 200 is removed, for troubleshooting purposes. In some other embodiments, PTO indicator 411 may be located outside housing 200 and visible to a user. PTO indicator 411 may be turned on when a PTO control signal is received by receiver module 125 to indicate that PTO 117 is to be turned on. The PTO control signal may be output through AN2+ channels 403 of receiver module 125 and pass through PTO indicator 411. The signal may then pass through an octocoupler 412 to electrically isolate the receiver module 125 and to prevent back feeding of high voltages from tractor 110.

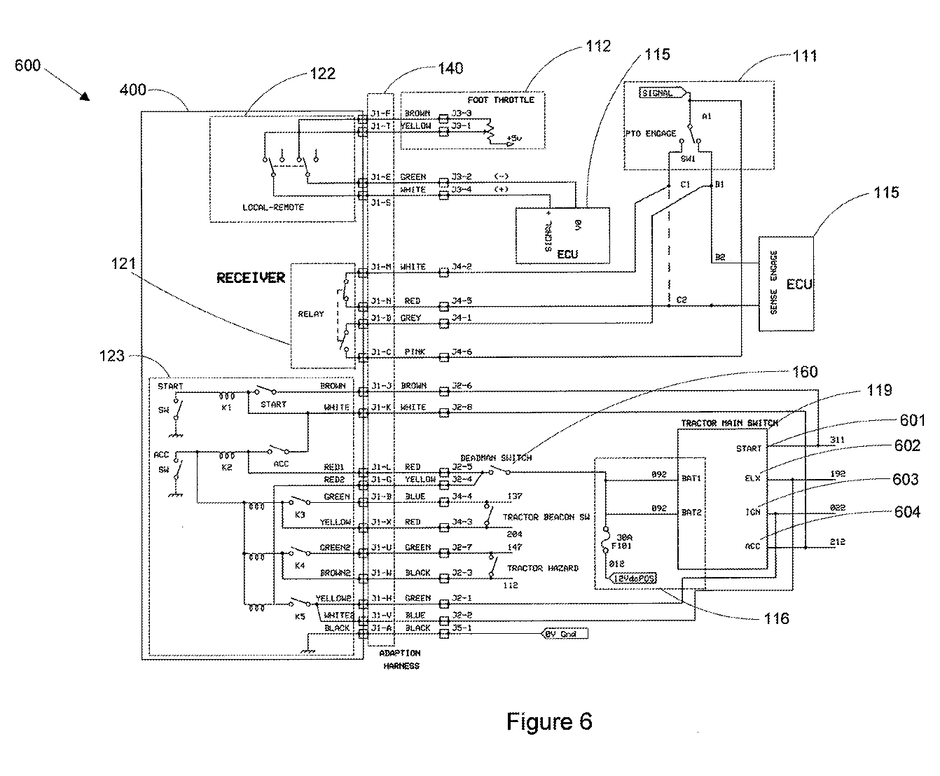

The PTO control signal may pass through PTO engage relay 413, which is activated by a signal from power supply 124. When PTO engage relay 413 is activated, the PTO control signal may cause switches 414 and 415 to switch. Signals from switches 414 and 415 are supplied through plug 260 to wiring harness 140, and to ECU 115 as illustrated in FIG. 6. ECU 115 then causes PTO 117 to turn on or off based on the signal received.

Throttle control circuitry 122 may receive throttle control signals from AN1+ and AN1− channels 401 and 402 of receiver module 125. The throttle control signal may pass through throttle control relay 416, which is activated by a signal from power supply 124. When throttle engage relay 416 is activated, switches 417 and 418 may be caused to switch, allowing the throttle control signal to be supplied through plug 260 to wiring harness 140, and to ECU 115 as illustrated in FIG. 6. ECU 115 then causes throttle 118 to be controlled based on the signal received.

Ignition control circuitry 123 may receive ignition and start control signals from D1+ and D2+ channels 407 and 409 of receiver module 125. D1+ channel 407 may provide the ignition control signal, and D2+ channel 409 may provide the start control signal. The ignition control signal may pass to ignition control relays 420, 421, 422 and 423, which are powered by a signal from power supply 124. The ignition control signal causes Earth to be supplied to relays ignition control relays 420, 421, 422 and 423, which causes these relays to be activated.

When ignition control relays 420, 421, 422 and 423 are activated, the ignition control signal may be supplied through plug 260 to wiring harness 140, and to ignition 119 of tractor 110 as illustrated in FIG. 6. The ignition control signals may then cause ignition 119 to be turned on and off based on the signal received.

The start control signal may cause Earth to be supplied to start control relay 419, which is powered by a signal from ignition control relay 420. When start control relays 419 is activated, the start control signal may be supplied through plug 260 to wiring harness 140, and to ignition 119 of tractor 110 as illustrated in FIG. 6. The ignition control signals may then cause ignition 119 to start tractor 110 based on the signal received.

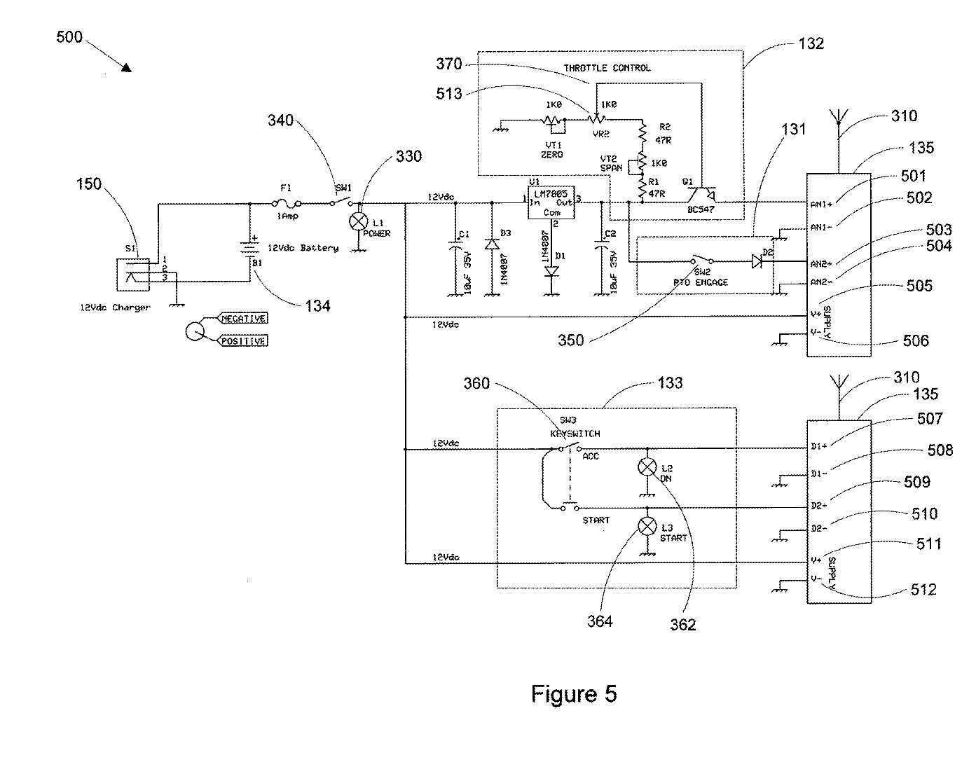

FIG. 5 shows a circuit diagram 500 of the electrical components of transmitter 130. Transmitter 130 includes transmitter modules 135, connected to antennae 310. Transmitter modules 135 transmit data signals using antennae 310 based on data signals received from PTO control circuitry 131, throttle control circuitry 132 and ignition control circuitry 133 through outputs 501 to 512. In the illustrated embodiment, two transmitter modules 135 are shown, but in some embodiments a different number of transmitter modules, such as one, three, four, five, or more, may be used.

Transmitter 130 has a power supply 134 which may be a 12 V battery in some embodiments. In some embodiments, power supply 134 may alternatively be two 9 V batteries, four AA batteries, or another combination of batteries. Battery 134 may be a rechargeable battery and may be able to be connected to a 12 V charger 150 in some embodiments. Transmitter 130 also has power indicator 330 powered by power supply 134 when power switch 340 is closed. Power indicator 330 may be an LED or another type of visual, audible, or other indicator. Power supply 134 supplies power to positive supply channels 505 and 511 of transmitter modules 135. Negative supply channels 506 and 512, as well as negative signal channels 502, 504, 508 and 510 of transmitter module 135 are connected to ground. Power supply 134 may also supply power to PTO control circuitry 132, throttle control circuitry 132 and ignition control circuitry 133.

PTO control circuitry 131 may produce a PTO control signal that is passed to AN2+ input channel 503 of transmitter module 135. PTO control circuitry 131 may include a PTO switch 350, which may be controllable by a user. Closing PTO switch 350 may allow a regulated voltage signal to be passed to input channel 503, which transmitter module 135 may pass to receiver module 125 as a signal to turn PTO 117 on. Opening PTO switch 350 may prevent the signal from being passed to input channel 503, causing PTO 117 to turn off.

Throttle control circuitry 132 may produce a throttle control signal that is passed to AN1+ input channel 501 of transmitter module 135. Throttle control circuitry may include a throttle dial 370 which may be a potentiometer 513 in some embodiments. In some other embodiments, throttle dial may be another dial, lever, or control means. In the illustrated embodiments, the throttle control signal is varied based on the resistance of potentiometer 513. By increasing and decreasing the resistance of potentiometer 513 using throttle dial 370, throttle 118 of tractor 110 may be varied.

Ignition control circuitry 133 may produce ignition and start control signals that are passed to D1+ and D2+ input channels 507 and 509. Ignition control circuitry 133 may include an ignition switch 360, which may be a key operated switch having three positions. In a first “Off” position, ignition switch 360 may be open, so that no signal is supplied to D1+ and D2+ input channels 507 and 509. In a second “Ignition” position, switch 360 may be partially closed, allowing a signal to travel to D1+ input 507, causing ignition indicator 362 to turn on, but not allowing a signal to pass to D2+ input 509. In a third “Start” position, switch 360 may be fully closed, allowing a signal to travel to D1+ input 507, causing ignition indicator 362 to turn on, and allowing a signal to travel to D2+ input 509, causing start indicator 364 to turn on. By turning switch 360 to the “Off”, “Ignition” and “Start” positions, ignition 119 of tractor 110 may be controlled.

FIG. 6 shows a circuit diagram 600 of some of the electrical components of tractor 110 interfacing with the electronics 400 of receiver 120. Circuitry 121, 122 and 123 of receiver 120 connect to the electronic components of tractor 110 through wiring harness 140. Dead-man switch 160 controls the supply of power to receiver 120 from power supply 116 of tractor 110, allowing for power to be selectively supplied to relays within receiver 120, as described above with reference to FIG. 4.

PTO control circuitry 121 interfaces to PTO switch 111 and ECU 115 of tractor 110 through wiring harness 140. When dead-man switch 160 is open, PTO switch 111 of tractor 110 is connected to ECU 115 of tractor 110, allowing PTO 117 to be controlled directly through the tractor 110 controls. PTO switch 111 may allow 12 V to be supplied to PTO 117, in order to activate PTO 117. When dead-man switch 160 is closed, ECU 115 receives signals from receiver 120, as received from transmitter 130 allowing remote control of PTO 117. Depending on the signal receiver, ECU 115 will be caused to supply 12 V to PTO 117, or to disconnect the 12 V supply.

Throttle control circuitry 122 interfaces to throttle control 112 and ECU 115 of tractor 110 through wiring, harness 140. When dead-man switch 160 is open, throttle control 112 of tractor 110 is connected to ECU 115 of tractor 110, allowing throttle 118 to be controlled directly through the tractor 110 controls. Throttle 118 may be controlled based on the voltage supplied from throttle control 112. For example, if 0 V are supplied, tractor 110 may idle, and a supply of 5 V may cause tractor 110 to high idle. The engine speed of tractor 110 may be dependent on the voltage supplied. When dead-man switch 160 is closed, ECU 115 receives signals from receiver 120, as received from transmitter 130, allowing remote control of throttle 118. The frequency of the signals received correspond to the amount of power supplied to throttle 118.

Different makes and models of tractor 110 may have different idle and high idle voltages. For example, in some embodiments, tractor 110 may idle at 0.5 V and have a high idle position of 4 V. In some other embodiments, tractor 110 may idle at 0.25 V and have a high idle position of 2 V. In some embodiments, receiver 120 may be configured to work with a variety of different tractors having a variety of idle and high idle voltages. Plug 260 of receiver 120 may be wired to allow for multiple voltage tractors, by having multiple sets of pins that can be plugged into wiring harness 160. By plugging wiring harness 160 to the connect set of pins in plug 260, multiple tractors having wiring harness 160 installed can be configured to use the same receiver 120. For example, for a 20 pin socket on wiring harness 160, a 40 pin plug 260 can be provided. The first 20 pins of socket 260 may be configured to provide 0.5 V to 4 V, while the remaining 20 pins may be configured to provide 0.25 V to 2 V.

Ignition control circuitry 123 interfaces to ignition 119 of tractor 110 through wiring harness 140. When dead-man switch 160 is open, ignition switch 113 of tractor 110 controls ignition 119. When dead-man switch 160 is closed, power is directed to receiver 120, allowing remote control of ignition 119 while ignition switch 113 of tractor 110 remains in an “Off” position. If an emergency stop of tractor 110 is required, dead-man switch 110 can be pressed to cut power to receiver 120, or ignition switch 360 of transmitter 130 could be switched to the “Off” position.

When dead-man switch 160 is closed, power is directed from power supply 116 of tractor 110 through dead-man switch 160 and to relays 420, 421, 422 and 423 of receiver 120 as described above with reference to FIG. 4. Relays 420, 421, 422 and 423 may be configured to allow control signals to be sent to ignition 119 to supply power to various components of tractor 110. Relay 420 may send a control signal to input ACC 604 of ignition 119 to control accessories of tractor 110, and power to relay 419. Relay 421 may send a control signal to a tractor rotating beacon 180 to indicate that the tractor is being remotely controlled. Relay 422 may send a control signal to tractor warning lights 170 to further indicate that the tractor is being remotely controlled. Relay 423 may send a control signal to inputs ELX 602 and IGN 603 of ignition 119 to control the electronics and ignition of tractor 110. Relay 419 may send a control signal to input START 601 of ignition 119 to control starting on tractor 110.

By connecting directly to ignition 119, the overriding remote control functions provided by receiver 120 are subject to all of the existing safety switches present in tractor 110. For example, tractor 110 may have safety mechanisms that prevent the tractor from being started if the gear levers (not shown) are in gear. Tractor 110 might require that it is in Neutral or Park in order to be started. By connecting receiver 120 to ignition 119, these safety measures are retained, even when controlling the tractor remotely through transmitter 130.

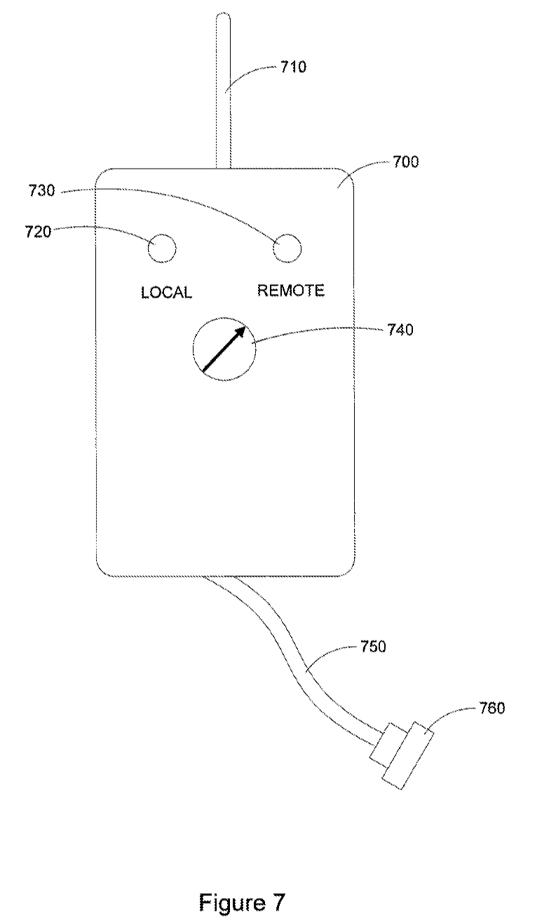

FIG. 7 shows an alternative embodiment of receiver 120. In the illustrated alternative embodiment, receiver 120 has a housing 700 which may be of a size and shape that can be hand held. Housing 700 contains PTO control circuitry 121, throttle control circuitry 122 ignition control circuitry 123, and receiver module 125. Receiver module 125 may be in communication with an antenna 710, which may protrude from housing 700. Receiver 120 may have a switch 740, which may be a rotatable switch having two positions. The switch may be movable between “local” and “remote” positions. Receiver 120 may have a local indicator 720 and a remote indicator 730. Indicators 720 and 730 may be LEDs in some embodiments. In some cases, indicator 720 may be of a different colour from indicator 730.

When switch 740 is moved to the “local” position, indicator 720 is turned on, and indicator 730 is turned off. Receiver 120 communicates with tractor 110 to cause tractor 110 to operate in a standard way, without allowing external control of the controllable elements of tractor 110. When switch 740 is moved to the “remote” position, indicator 730 may be turned on and indicator 720 may be turned off. Receiver 120 may communicate with tractor 110 to cause tractor 110 to operate based on instructions received from transmitter 130, allowing external control of the controllable elements of tractor 110.

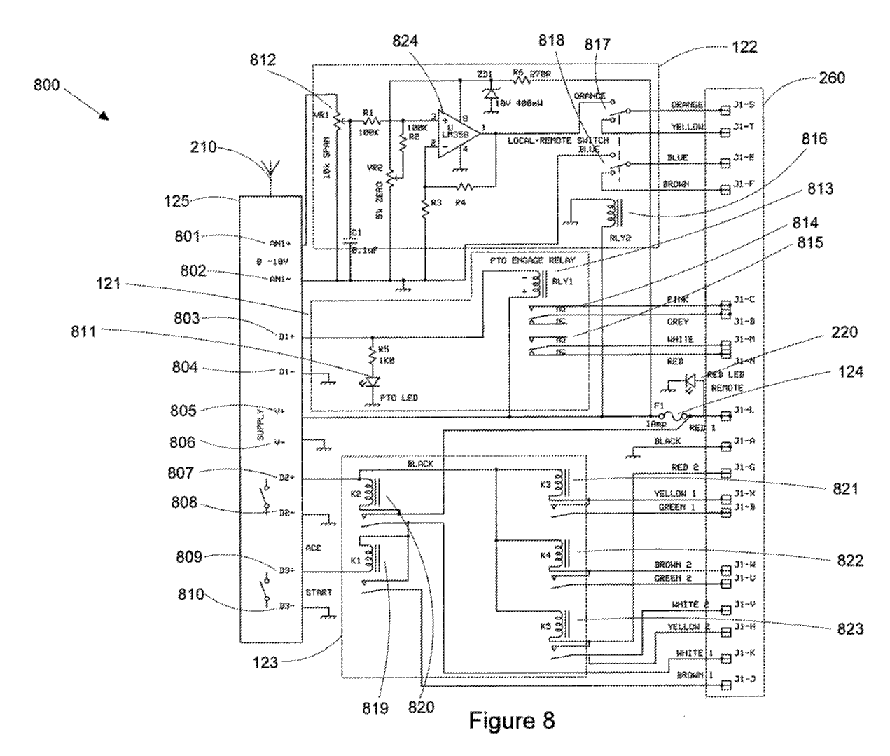

FIG. 8 shows an alternative circuit diagram 800 of the electrical components of receiver 120. As described above with reference to FIG. 4, receiver 120 includes receiver module 125, connected to antenna 210. Receiver module 125 receives data signals front antenna 210 and outputs data signals to PTO control circuitry 121, throttle control circuitry 122 and ignition control circuitry 123 through outputs 801 to 810. Outputs from PTO control circuitry 121, throttle control circuitry 122 and ignition control circuitry 123 are passed to plug 260 which connects to wiring harness 140, to enable control of tractor 110. In the illustrated embodiment, one receiver module 125 is shown, but in some embodiments a different number of receiver modules, such as two, three, four, five, or more, may be used.

Receiver 120 also has a power supply 124 connected to plug 260 to receive power from power supply 116 of tractor 110. Receiver 120 also has power indicator 220 powered by power supply 124 when power supply 124 is receiving power from power supply 116. Power indicator 220 is a red LED in the illustrated embodiment, but may be a different coloured LED, or another type of visual, audible, or other indicator in some embodiments. Power supply 124 supplies power to positive supply channel 805 of receiver module 125. Negative supply channel 806, as well as negative output channels 804, 808 and 810 of receiver module 125 are connected to Earth. Power supply 124 powers relays 813, 816, 820, 821, 822 and 823 when power supply 124 receives power from power supply 116 through dead-man switch 160. Although power is supplied to these relays, no action will result due to the relays not being connected to Earth.

PTO control circuitry 121 may receive PTO control signals from D1+ channel 803 of receiver module 125. PTO circuitry 121 may include PTO indicator 811, which may be an LED in some embodiments. PTO indicator 811 may be internal of the receiver housing 200 in some embodiments, and only visible when housing 200 is removed, for troubleshooting purposes. In some other embodiments, PTO indicator 811 may be located outside housing 200 and visible to a user. PTO indicator 811 may be turned on when a PTO control signal is received by receiver module 125 to indicate that PTO 117 is to be turned on. The PTO control signal may be output through D1+ channels 803 of receiver module 125 and pass through PTO indicator 811.

The PTO control signal may pass through PTO engage relay 813, which is activated by a signal from power supply 124. When PTO engage relay 813 is activated, the PTO control signal may cause switches 814 and 815 to switch. Signals from switches 814 and 815 are supplied through plug 260 to wiring harness 140, and to ECU 115 as illustrated in FIG. 6. ECU 115 then causes PTO 117 to turn on or off based on the signal received.

Throttle control circuitry 122 may receive throttle control signals from AN1+ and AN1− channels 801 and 802 of receiver module 125. The throttle control signals may control a potentiometer 812, the output of which is varied based on the resistance of potentiometer 813. By increasing and decreasing the resistance of potentiometer 813, throttle 118 of tractor 110 may be varied.

The throttle control signal may further pass through an operational amplifier 824, which may be an LM358 operational amplifier in some embodiments. Throttle control relay 816 may be activated by a signal from power supply 124. When throttle engage relay 816 is activated, switches 817 and 818 may be caused to switch, allowing the signal from operational amplifier 824 to be supplied through plug 260 to wiring harness 140, and to ECU 115 as illustrated in FIG. 6. ECU 115 then causes throttle 118 to be controlled based on the signal received.

Ignition control circuitry 123 may receive ignition and start control signals from D2+ and D3+ channels 807 and 809 of receiver module 125. D2+ channel 807 may provide the ignition control signal, and D3+ channel 809 may provide the start control signal. The ignition control signal may pass to ignition control relays 820, 821, 822 and 823, which are powered by a signal from power supply 124. The ignition control signal causes Earth to be supplied to relays ignition control relays 820, 821, 822 and 823, which causes these relays to be activated.

When ignition control relays 820, 821, 822 and 823 are activated, the ignition control signal may be supplied through plug 260 to wiring harness 140, and to ignition 119 of tractor 110 as illustrated in FIG. 6. The ignition control signals may then cause ignition 119 to be turned on and off based on the signal received.

The start control signal may cause Earth to be supplied to start control relay 819, which is powered by a signal from ignition control relay 820. When start control relays 819 is activated, the start control signal may be supplied through plug 260 to wiring harness 140, and to ignition 119 of tractor 110 as illustrated in FIG. 6. The ignition control signals may then cause ignition 119 to start tractor 110 based on the signal received.

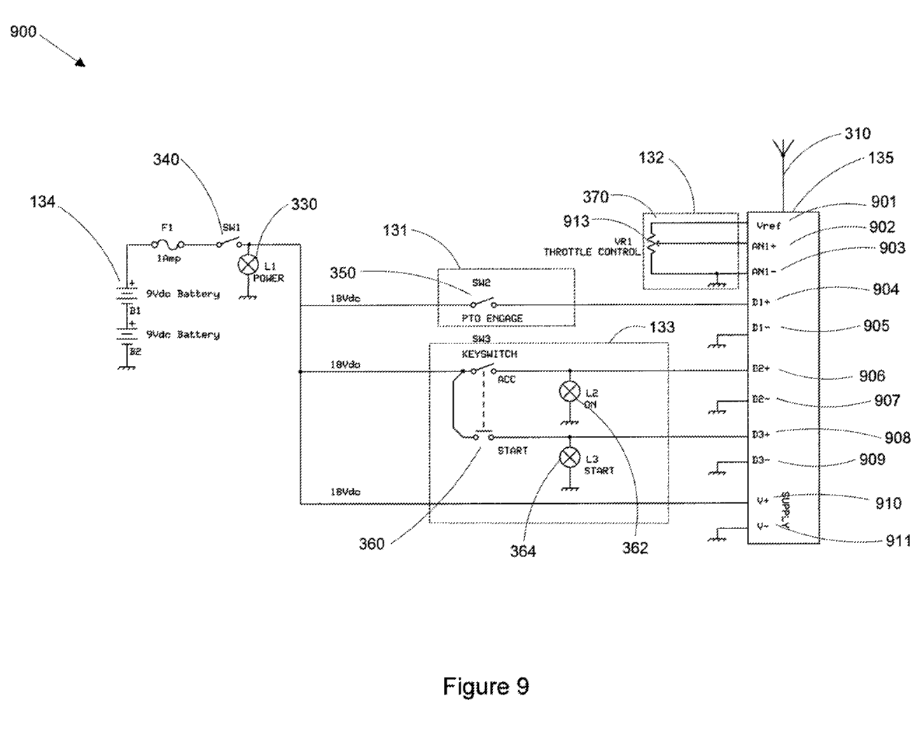

FIG. 9 shows an alternative circuit diagram 900 of the electrical components of transmitter 130. Transmitter 130 includes transmitter module 135, connected to antennae 310. Transmitter module 135 transmits data signals using antennae 310 based on data signals received from PTO control circuitry 131, throttle control circuitry 132 and ignition control circuitry 133 through outputs 901 to 911. In the illustrated embodiment, one transmitter module 135 are shown, but in some embodiments a different number of transmitter modules, such as two, three, four, five, or more, may be used.

Transmitter 130 has a power supply 134 which may be two 9 V batteries in some embodiments. In some embodiments, power supply 134 may alternatively be a 12 V battery, four AA batteries, or another combination of batteries. Battery 134 may be a rechargeable battery and may be able to be connected to a 12 V charger 150 in some embodiments. Transmitter 130 also has power indicator 330 powered by power supply 134 when power switch 340 is closed. Power indicator 330 may be an LED or another type of visual, audible, or other indicator. Power supply 134 supplies power to positive supply channel 910. Negative supply channel 911, as well as negative signal channels 905, 907 and 911 of transmitter module 135 are connected to ground. Power supply 134 may also supply power to PTO control circuitry 132, throttle control circuitry 132 and ignition control circuitry 133.

PTO control circuitry 131 may produce a PTO control signal that is passed to D1+ input channel 904 of transmitter module 135. PTO control circuitry 131 may include a PTO switch 350, which may be controllable by a user. Closing PTO switch 350 may allow a voltage signal to be passed to input channel 904, which transmitter module 135 may pass to receiver module 125 as a signal to turn PTO 117 on. Opening PTO switch 350 may prevent the signal from being passed to input channel 905, causing PTO 117 to turn off.

Throttle control circuitry 132 may produce a throttle control signal that is passed to AN1+ input channel 902 of transmitter module 135. Throttle control circuitry may include a throttle dial 370 which may be a potentiometer 913 in some embodiments. In some other embodiments, throttle dial may be another dial, lever, or control means. In the illustrated embodiments, the throttle control signal is varied based on the resistance of potentiometer 913, based on a reference voltage supplied through Vref channel 901. By increasing and decreasing the resistance of potentiometer 913 using throttle dial 370, throttle 118 of tractor 110 may be varied.

Ignition control circuitry 133 may produce ignition and start control signals that are passed to D2+ and D3+ input channels 906 and 908. Ignition control circuitry 133 may include an ignition switch 360, which may be a key operated switch having three positions. In a first “Off” position, ignition switch 360 may be open, so that no signal is supplied to D2+ and D3+ input channels 906 and 908. In a second “Ignition” position, switch 360 may be partially closed, allowing a signal to travel to D2+ input 906, causing ignition indicator 362 to turn on, but not allowing a signal to pass to D3+ input 908. In a third “Start” position, switch 360 may be fully closed, allowing a signal to travel to D2+ input 906, causing ignition indicator 362 to turn on, and allowing a signal to travel to D3+ input 908, causing start indicator 364 to turn on. By turning switch 360 to the “Off”. “Ignition” and “Start” positions, ignition 119 of tractor 110 may be controlled.

The alternative electronic diagrams 800 and 900 illustrated in FIGS. 8 and 9 allow for transmitter 130 to be of a smaller size, making it more easy to handle, by removing some electronic components from transmitter 130, and placing additional electronic components in receiver 120.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A receiver device for controlling agricultural machinery, comprising:
a receiver module for communicating with an external device;
throttle control circuitry in communication with the receiver module, configured to override a built-in throttle control mechanism of the machinery and allow for control of a throttle function of the machinery;
ignition control circuitry in communication with the receiver module, configured to override a built-in ignition control mechanism of the machinery and allow for control of an ignition function of the machinery; and
auxiliary apparatus control circuitry in communication with the receiver module, configured to override a built-in auxiliary apparatus control mechanism of the machinery and allow for control of an auxiliary apparatus function of the machinery;
wherein the device is configured to control at least one of the throttle function, the ignition function and the auxiliary apparatus function in response to control signals received at the receiver module from the external device.

2. The receiver device of claim 1, wherein the ignition control circuitry is configured to allow at least one ignition safety feature of the machinery to continue to operate when the built-in ignition control mechanism of the machinery is overridden.

3. The receiver device of claim 1, wherein the receiver module is configured to be removably installable in the machinery.

4. The receiver device of claim 3, wherein the receiver module is configured to be plugged into a wiring harness of the machinery.

5. The receiver device of claim 3, wherein the receiver is configured to be able to control at least two pieces of machinery, the at least two pieces of machinery having different idle and high idle voltages from each other.

6. The receiver device of claim 5, wherein the receiver comprises a plug having at least two sections, each section of the plug being adapted to be used with a piece of machinery having a particular idle and high idle voltage.

7. A kit for retrofitting to agricultural machinery comprising:
the receiver device of claim 1; and
a transmitter device comprising:
a transmitter module for communicating with the receiver module of the receiver device;
throttle control circuitry configured to receive input from a user and to communicate with the transmitter module based on the input;
ignition control circuitry configured to receive input from a user and to communicate with the transmitter module based on the input; and
auxiliary apparatus control circuitry configured to receive input from a user and to communicate with the transmitter module based on the input.

8. The kit of claim 7, further comprising a wiring harness configured to be installed in the machinery, the receiver module being configured to plug into the wiring harness.

9. The receiver device of claim 2, wherein the receiver module is configured to be removably installable in the machinery.

10. The receiver device of claim 9, wherein the receiver is configured to be plugged into a wiring harness of the machinery.

11. The receiver device of claim 9, wherein the receiver is configured to be able to control at least two pieces of machinery, the at least two pieces of machinery having different idle and high idle voltages from each other.

12. The receiver device of claim 10, wherein the receiver is configured to be able to control at least two pieces of machinery, the at least two pieces of machinery having different idle and high idle voltages from each other.

13. The receiver device of claim 10, wherein the receiver comprises a plug having at least two sections, each section of the plug being adapted to be used with a piece of machinery having a particular idle and high idle voltage.

14. The receiver device of claim 11, wherein the receiver comprises a plug having at least two sections, each section of the plug being adapted to be used with a piece of machinery having a particular idle and high idle voltage.

15. The receiver device of claim 12, wherein the receiver comprises a plug having at least two sections, each section of the plug being adapted to be used with a piece of machinery having a particular idle and high idle voltage.

16. A kit for retrofitting to agricultural machinery comprising:
the receiver device of any one of claims 2 to 6; and
a transmitter device comprising:
a transmitter module for communicating with the receiver module of the receiver device;
throttle control circuitry configured to receive input from a user and to communicate with the transmitter module based on the input;
ignition control circuitry configured to receive input from a user and to communicate with the transmitter module based on the input; and
auxiliary apparatus control circuitry configured to receive input from a user and to communicate with the transmitter module based on the input.
